(19) United States
(12) Patent Application Publication
(10) Pub. No.: US 2015/0002658 A1
(43) Pub. Date: Jan. 1, 2015

(54) LIQUID LEVEL MEASURING DEVICE

(71) Applicant: NATIONAL TAIWAN OCEAN UNIVERSITY, Keelung City (TW)

(72) Inventors: SHENQ-YUH JAW, Keelung City (TW); JIAHN-HORNG CHEN, Keelung City (TW); TAI-WEN HSU, Tainan City (TW); KEH-CHIA YEH, Hsinchu City (TW); SHENG-HSUEH YANG, Yunlin County (TW)

(73) Assignee: NATIONAL TAIWAN OCEAN UNIVERSITY, Keelung City (TW)

(21) Appl. No.: 14/058,364

(22) Filed: Oct. 21, 2013

(30) Foreign Application Priority Data
Jun. 28, 2013 (TW) 102123307

(51) Int. Cl. G01F 23/00

(52) U.S. Cl. CPC G01F 23/0061
USPC 348/135

(57) ABSTRACT

A liquid level measuring device includes a container and a digital electronic device. The container is located at a detection region. The container has an opening, so that a liquid is permitted to flow into the container through the opening. The digital electronic device is combined with the container. The digital electronic device includes a lens, and an optical axis of the lens is directed to and perpendicular to a detection plane. A light source illuminates the detection plane. The lens is operated in a fixed-focus mode to shoot the detection plane to acquire an image stream. Each image frame of the image stream contains a corresponding liquid surface image. After an image analyzing operation is performed on the corresponding liquid surface image to calculate the corresponding liquid surface image, a liquid level of the liquid is realized.

### FIELD OF THE INVENTION

The present invention relates to a liquid level measuring device, and more particularly to a liquid level measuring device for accurately and precisely measuring a liquid level in a detection region by using a digital electronic device to capture images, using an inclined partition structure and a light-transmission part and performing an image processing technology (e.g. a sub-pixel accuracy analysis).

### BACKGROUND OF THE INVENTION

In Taiwan, heavy rainfall may easily occur in the plum rain season or in the typhoon season. As known, the steep terrain of the mountains in Taiwan may cause the rapid flowing rivers and short collecting time of the rivers. If the hillsides are over-developed or the hydraulic facilities have not been installed before the flood season, the occurrence of heavy rainfall often causes landslides in mountains, serious flood in the urban regions, midstream and downstream of rivers, or other serious disasters. Nowadays, the climate change causes the increased frequency of the extreme and violent weather events. Due to these meteorological factors, the possibility of causing natural disasters will increase. Therefore, the government should make efforts in prevention, early warning or preparation of such disasters.

For accurately and early warning the possible disasters caused by rainfall in associated regions, in addition to the quantitative precipitation forecast beforehand, it is essential to observe the water level and the water flow rate of these regions. As for water level observation, the water levels or flooding depths of rivers, lakes, reservoirs, embankments, roads, undergrounds or other regions are observed. In case that the water level reaches a warning line or the water level is high enough to affect safety, the relevant personnel should alert, announce or provide information to relevant organizations in order to avoid expansion of the disaster. In other words, it is important to observe the water levels of these regions in an actual and real-time manner.

In accordance with the conventional technologies, the water level is manually measured, or a graduation line around the water body is directly observed. Moreover, the conventional water level observation devices include for example float-type water level gauges, pressure-type water level gauges, acoustic-type water level gauges, radar-type water level gauges, or the like. According to the water fluctuation, these conventional water level observation devices can realize the corresponding water levels by specified detection and calculation methods. However, these water level observation devices still have some drawbacks. For example, since some of these devices are read by human judgment, the accuracy and the real-time measuring efficacy are usually unsatisfied. In addition, some of these devices have high fabricating cost and thus fail to be widely installed. Moreover, since some of these devices measure the water level by contacting the devices with water surfaces, it is difficult to maintain the devices.

On the other hand, some of the conventional water level observation devices have the automatic observing functions or are equipped with image capturing devices to shoot the water surfaces. These technologies are disclosed in for example Taiwanese Patent No. 1384205 (entitled “Measure method for the height of a liquid surface”) and Korean Patent No. 1020120003746 (entitles “Method and device for measuring a rainfall”). However, the approaches of transmitting the observed data to a back-end device and processing the observed data in the back-end device are complicated. Moreover, since the processes of capturing images are readily interfered by the ambient light beams, the results of the water level judgment are neither accurate nor precise.

Therefore, there is a need of providing an improved liquid level measuring device in order to overcome the above drawbacks.

### SUMMARY OF THE INVENTION

The present invention provides a liquid level measuring device. The liquid level measuring device has a digital electronic device for capturing images. Moreover, by means of an inclined partition structure and a light-transmission part and by analyzing a sub-pixel accuracy of the captured images, the liquid level change can be measured more accurately and precisely. Consequently, the liquid level of the liquid in a detection region can be accurately realized. Moreover, the container is made of an opaque material, and the outer appearance of the container is designed as a sealed structure. Since the ambient light beams are nearly blocked from entering the container, the processes of capturing images are not interfered by the ambient light beams. Moreover, since the known digital electronic device and the known light source are employed for capturing images, processing and analyzing images, transmitting signals and illuminating the detection plane, the installation cost of the liquid level measuring device is reduced, and associated images and information can be immediately provided.

In accordance with an aspect of the present invention, there is provided a liquid level measuring device. The liquid level measuring device includes a container and a digital electronic device. The container is located at a detection region. The container has an opening, so that a liquid is permitted to flow into the container through the opening. The digital electronic device is combined with the container. The digital electronic device includes a lens, and an optical axis of the lens is directed to and perpendicular to a detection plane. A light source illuminates the detection plane. The lens is operated in a fixed-focus mode to shoot the detection plane to acquire an image stream. Each image frame of the image stream contains a corresponding liquid surface image. After an image analyzing operation is performed on the corresponding liquid surface image to calculate the corresponding liquid surface image, a liquid level of the liquid is realized.

In an embodiment, for performing the image analyzing operation, an area of the liquid surface image contained in each image frame is calculated, or changes of liquid surface edges of two image frames are calculated and compared with each other, and a Gaussian distribution method or a Centroid method is further used to analyze a sub-pixel accuracy, so that the corresponding liquid level is acquired.

In an embodiment, the liquid level measuring device further includes a partition structure. The partition structure is disposed within the container and inclined relative to a lower portion of the container. The partition structure includes a light-transmissible part with a linear slope. The corresponding liquid surface image is an image of the liquid which is visible through the light-transmissible part, and the corresponding liquid surface image is indicated as a bright fringe.

In an embodiment, the partition structure is a flat plate, a trapezoidal pyramid structure or a cone structure. In addition, the light-transmissible part is arranged in an oblique line or a helical line.

In an embodiment, the opening is formed on an upper portion of the container, and a water collector is disposed in the opening of the container. The partition structure is a pipe structure with a fixed diameter and connected with the water collector.

In an embodiment, for performing the image analyzing operation, positions of the bright fringes of any two image frames are calculated and compared with each other, and a Gaussian distribution method or a Centroid method is further used to analyze a sub-pixel accuracy, so that the corresponding liquid level is acquired.

In accordance with another aspect of the present invention, there is provided a liquid level measuring device. The liquid level measuring device includes a shielding container and a digital electronic device. The shielding container is located at a detection region. The shielding container has an opening, so that a liquid is permitted to flow into the container through the opening. The digital electronic device is disposed within the shielding container. The digital electronic device includes a lens, and an optical axis of the lens is directed to a detection plane. A light source illuminates the detection plane. The lens shoots the detection plane to acquire an image stream. Each image frame of the image stream contains a corresponding liquid surface image. After an image analyzing operation is performed on the corresponding liquid surface image to calculate the corresponding liquid surface image, a liquid level of the liquid is realized.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a liquid level measuring device according to a first embodiment of the present invention;

FIG. 2A schematically illustrates a continuous image-capturing result of the liquid level measuring device according to the first embodiment of the present invention;

FIG. 2B schematically illustrates the image formation by the lens of the liquid level measuring device according to the first embodiment of the present invention;

FIG. 3A is a schematic view illustrating a liquid level measuring device according to a second embodiment of the present invention;

FIG. 3B is a schematic side view illustrating the partition structure of the liquid level measuring device according to the second embodiment of the present invention;

FIG. 4A schematically illustrates a continuous image-capturing result of the liquid level measuring device according to the second embodiment of the present invention;

FIG. 4B schematically illustrates the image formation by the lens of the liquid level measuring device according to the second embodiment of the present invention;

FIG. 5 is a schematic view illustrating a liquid level measuring device according to a third embodiment of the present invention;

FIG. 6A schematically illustrates a continuous image-capturing result of the liquid level measuring device according to the third embodiment of the present invention;

FIG. 6B schematically illustrates the image formation by the lens of the liquid level measuring device according to the third embodiment of the present invention; and

FIG. 7 is a schematic view illustrating a liquid level measuring device according to a fourth embodiment of the present invention.

### DETAILED DESCRIPTION OF THE PREFERRED EMBODIMENT

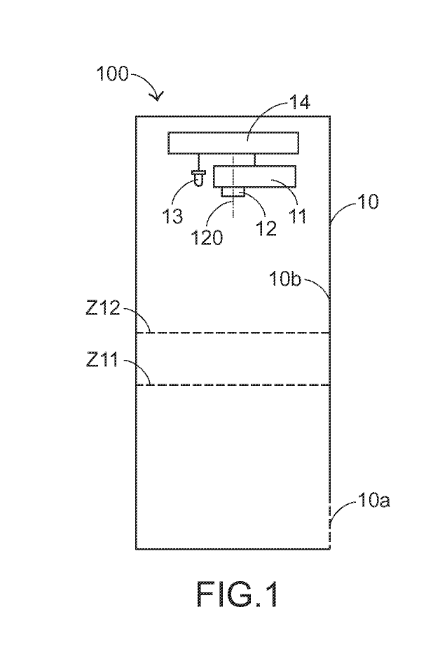

Hereinafter, a liquid level measuring device of a first embodiment of the present invention will be illustrated. FIG. 1 is a schematic view illustrating a liquid level measuring device according to a first embodiment of the present invention. As shown in FIG. 1, the liquid level measuring device 100 comprises a container 10 and a digital electronic device 11. The digital electronic device 11 is combined with and disposed within the container 10. The container 10 is located at a detection region for measuring a liquid level of a liquid. The detection region is for example a river, a lake, a reservoir, an embankment, a road, an undergrounds or any other water-collecting region. The liquid is for example rain water or river water. In case of rainfall or centralized water, the water level at some positions of the water-collecting region or the water level of the whole water-collecting region will increase. The container 10 has an opening 10a. In this embodiment, the opening 10a is located at a lower portion of the container 10. Consequently, the liquid in the water-collecting region can flow into the container 10 through the opening 10a. In accordance with a feature of the present invention, the liquid level measuring device 100 is used for measuring the liquid level of the liquid within the container 10.

In this embodiment, the liquid level measuring device 100 further comprises a light source 13 and an external power source 14. The digital electronic device 11 comprises a lens 12 for capturing images or taking photos. In this embodiment, the light source 13 is composed of at least one light emitting diode unit. The container 10 is a cylindrical or tubal structure with a closed top end. In addition, the container 10 is made of an opaque material. That is, except for the opening 10a, the inner portion and the outer portion of the container 10 are isolated from each other. Since a great portion of the ambient light beams fail to be introduced into the container 10, the interference of the ambient light beams will be minimized. In other words, the light source 13 is used for supplementing brightness while the lens 12 captures images. The light emitting diode unit has many benefits such as high brightness, low power consumption and long use life. Consequently, the light emitting diode unit can provide the lighting efficacy for a long time. In some embodiments, the light emitting diode unit of the light source 13 is designed to be operated in a synchronous flash control mode. That is, when the lens 12 captures images, the light emitting diode unit of the light source 13 synchronously flashes. Under this circumstance, it is not necessary for the light source 13 to lengthily or continuously provide the light beams.

Generally, the digital electronic device 11 has a built-in storage battery that provides electric power required for its operations. However, for continuously measuring the liquid level, the electric power to be supplied to the digital electronic device 11 should be stable and sustained. The external power source 14 is used for providing the electric power to the digital electronic device 11 and the light source 13. For example, the external power source 14 is a utility power source, a solar energy supply unit or a wind power supply unit. For installing the external power source 14, the isolation between the inner portion and the outer portion of the container 10 should be taken into consideration. For example, a solar panel of the solar energy supply unit or a wind turbine of the wind power supply unit is located at the outer portion of the container 10 for transferring electric power to the inner portion of the container 10 through a power cable. Moreover, the electric power is stored in a storage battery within the container 10 or directly transferred to the digital electronic device 11.

In this embodiment, the light source 13 and the digital electronic device 11 are separate units. Alternatively, in some other embodiments, the light source 13 is included in the digital electronic device 11. For example, the light source 13 is a flash lamp of the digital electronic device 11. In particular, the digital electronic device 11 is a smart phone, a tablet personal computer or a notebook computer. In the state-of-the-art technology, the smart phone, the tablet personal computer or the notebook computer is usually equipped with a camera module or a lens having the functions of capturing images or taking photos. That is, the digital electronic device 11 is equipped with a charge coupled device (CCD) or a complementary metal-Oxide-semiconductor (CMOS), which is well known in the art. Moreover, the digital electronic device 11 further comprises a memory unit, a central processing unit and a signal transmission unit (not shown). After the tasks of capturing images or taking photos are performed, the associated images are stored, processed and transmitted by the memory unit, the central processing unit and the signal transmission unit, respectively.

Please refer to FIG. 1 again. After the digital electronic device 11 is installed, the lens 12 faces the lower portion of the container 10. An optical axis 120 of the lens 12 is directed to and perpendicular to a detection plane. In particular, after the container 10 is vertically disposed in the detection region and the liquid flows into the container 10, the optical axis 120 of the lens 12 is perpendicular to a surface of the liquid (i.e. the detection plane). The height of the container 10 is determined according to the detection region. That is, the liquid level of the detection region may be indicated by the height of the surface of the liquid in the container 10. Moreover, for preventing the liquid from overflowing or submerging the digital electronic device 11 because of the flow rate increase, the characteristics of the liquid in the detection region should be taken into consideration. Moreover, the two liquid levels shown in FIG. 1 indicate the rising and lowering situations of the liquid at two different time points.

Moreover, under the illumination of the light source 13, the lens 12 shoots the liquid to acquire an image stream. Each image frame of the image stream contains a liquid surface image corresponding to the liquid. In this embodiment, the lens 12 is operated in a fixed focus mode to capture images. That is, without manual manipulation, the lens 12 is programmed to capture images at fixed focal length, wherein the zooming in function and the zooming out functions of the lens 12 are not done. Consequently, the displaying regions of the images captured at different time points indicate the target regions with the same size. By means of this design, the target images will have a fixed range and a fixed scaling factor in the subsequent image processing and analyzing processes. Consequently, the measurement and judgment of the liquid level can be corresponding performed.

According to the photographing principles, the zooming-in action of the lens generates an image-capturing result with a smaller viewing angle and a larger target region, and the zooming-out action of the lens generates an image-capturing result with a larger viewing angle and a smaller target region. In this embodiment, the focal length of the lens 12 has been previously set. Consequently, each image frame of the image stream contains not only the liquid surface image (i.e. the whole image of the surface of the liquid), but also an image of a part of an inner wall 10b of the container 10. Please refer to FIG. 1 again. After the liquid flows into or flows out of the container 10 and the liquid level changes, the liquid level changes may be realized by calculating and judging the area of the liquid surface. If the lens 12 is zoomed in and the liquid surface image exceeds the image of the inner wall 10b, the calculation and judgment are not accurate. In other words, if the image of the inner wall 10b is not shown, it is impossible to realize the change of the liquid level.

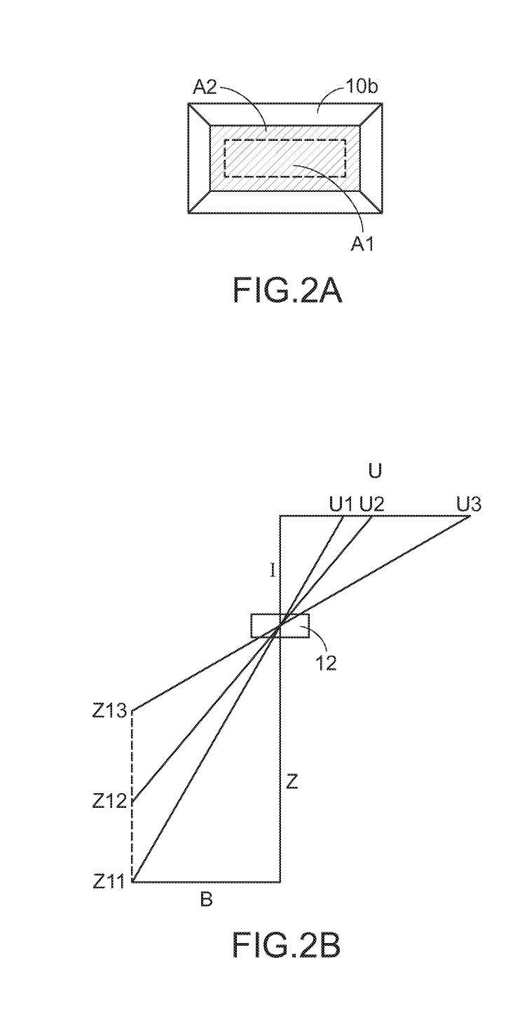

FIG. 2A schematically illustrates a continuous image-capturing result of the liquid level measuring device according to the first embodiment of the present invention. Since the lens 12 is operated in the fixed focus mode, the size of the target region is fixed. That is, the image of the inner wall 10b contained in the image frame is unchanged. For example, in FIG. 1, two liquid levels Z11 and Z12 are shown. The liquid level Z11 indicates the liquid level at a first time point (e.g. an older time point) and corresponding to a liquid surface area A1 (see FIG. 2A). The liquid level Z12 indicates the liquid level at a second time point (e.g. a newer time point) and corresponding to a liquid surface area A2 (see FIG. 2A). In the image frame, the liquid surface area A2 is larger than the liquid surface area A1. That is, during the time interval between the first time point and the second time point, the liquid surface rises.

It is noted that the image frame at the first time point and the image frame at the second time point are different. In FIG. 2A, these two image frames are superimposed with each other in order to facilitate observing the area change. Moreover, when the design of the camera module or the lens of the general digital electronic device and the physical properties of the flow rate of the general liquid are taken into consideration, the refresh rate of the image frame of the lens is faster than the speed of the liquid level change. Consequently, the two images shown in FIG. 2A are not two consecutive images of the image stream. In particular, the two images shown in FIG. 2A are captured at two time points, wherein these two time points are separated by a specified time interval.

Moreover, after an image analyzing operation is performed on a liquid surface image, a corresponding liquid level is obtained. The image analyzing operation is a well-known image processing and analyzing technology. For example, a Gaussian distribution method or a Centroid method may be used to analyze the sub-pixel accuracy. For example, since the liquid surface image and the inner wall image are obviously different in colors and brightness values, the Gaussian distribution method may be employed to distinguish from the peak values of the pixels of the image in order to judge which pixels of the image frame indicate the liquid surface or the inner wall or whether the pixels representative of the liquid surface are increased or decreased.

In this embodiment, the central processing unit is used for processing the image stream and storing the image stream into the memory unit. The image analyzing operation is performed by the central processing unit to calculate the area of the liquid surface image contained in each image frame. Alternatively, for performing the image analyzing operation, the unchanged portions of the liquid surfaces of two image frames are not taken into consideration, but only the changes of the liquid surface edges of the two image frames are calculated and compared.

Then, according to a sub-pixel accuracy algorithm, a sub-pixel displacement from a peak value of the Gaussian distribution curve to a peak value of an image brightness distribution curve is calculated to acquire the displacement or the change amount of the liquid surface edge. For example, if the peak value of the image brightness distribution curve has a coordinate (m,n), according to the following Gaussian distribution equation (1), the sub-pixel displacement Δx from the peak value of the Gaussian distribution curve to the peak value m of the image brightness distribution curve can be obtained. Consequently, the displacement of the liquid surface edge in the x-direction is equal to m+Δx. Similarly, the displacement of the liquid surface edge in the y-direction is equal to n+Δy. In particular, if the calculation of the sub-pixel displacement is not performed, the precision is only one half of a pixel. Whereas, if the calculation of the sub-pixel displacement is performed, the precision is enhanced (e.g. several tenths to several hundredths of one pixel).

$$Δ x = \frac{ln ( {Z}_{m - 1} ) - ln ( {Z}_{m + 1} )}{2 [ ln ( {Z}_{m + 1} ) - 2 ln ( {Z}_{m} ) + ln ( {Z}_{m - 1} ) ]} \qquad ( 1 )$$

In equation (1), Zₙ, is the image intensity of the pixel m
Consequently, if the relationship between each pixel of the image frame and the actual height or distance has been previously known, the sub-pixel displacement can be converted into the actual rising or lowering extent of the liquid level. In particular, after all image frames are continuously subjected to the above calculation or the image frames separated by a specified time interval are subjected to the above calculation, the calculating result about the rising or lowering extent of the liquid level is accumulated or compared with the initial value that is obtained in the beginning of the measurement. Consequently, the change of the liquid level within an operating time period and the actual liquid level of the liquid in the detection region can be realized.

Moreover, the central processing unit may be programmed to generate a corresponding warning signal when the liquid level reaches a preset value. The warning signal is transmitted to a back-end device through the signal transmission unit in order to prompt or warn the user or the guarder. Moreover, in addition to the warning signal, the acquired image stream is also transmitted through the signal transmission unit simultaneously. Alternatively, according to the practical requirements, the image stream may be transmitted to the back-end device at a specified time point. Under this circumstance, the real scene can be watched in real time while avoiding transmitting huge amount of data.

Moreover, if the signal transmission unit of the digital electronic device 11 has a wireless transmission function, associated signals are transmitted by a wireless transmission technology. Alternatively, the digital electronic device 11 may be connected with the back-end device through a network cable, and associated signals are transmitted by a wired transmission technology. Moreover, the image analyzing operation may be directly performed by the central processing unit of the digital electronic device 11 at the local end. Alternatively, the image analyzing operation may be performed by the back-end device. For example, the digital electronic device is a web camera. The web camera is only able to capture images. Moreover, the image stream is simultaneously transmitted to the back-end device, and analyzed by the back-end device.

FIG. 2B schematically illustrates the image formation by the lens of the liquid level measuring device according to the first embodiment of the present invention. As shown in FIG. 2B, the term “I” denotes the focal length of the lens 12, the term “U” (e.g. U1, U2 and U3) denotes the distance between the image and the central axis of the lens 12 (also referred as the image length), the term “Z” (e.g. Z11, Z12 and Z13) denotes the distance between the liquid surface and the lens 12 (i.e. the object distance), and the term “B” denotes the distance between the object and the central axis of the lens 12. According to the similar triangle relationship, U/I=B/Z. If the focal length I is fixed, the size of the target region acquired by the lens 12 is fixed. That is, B is fixed. Since U×Z=I×B=constant, the image length U is in reverse proportion to the object distance Z. In other words, the object distance Z is larger, and the image length U is smaller. From the above discussion, the use of the lens 12 in the fixed focus mode is able to realize the change of the liquid surface. However, since different image lengths U are generated in response to different liquid levels, the precision and sensitivity of measurement may be unsatisfied.

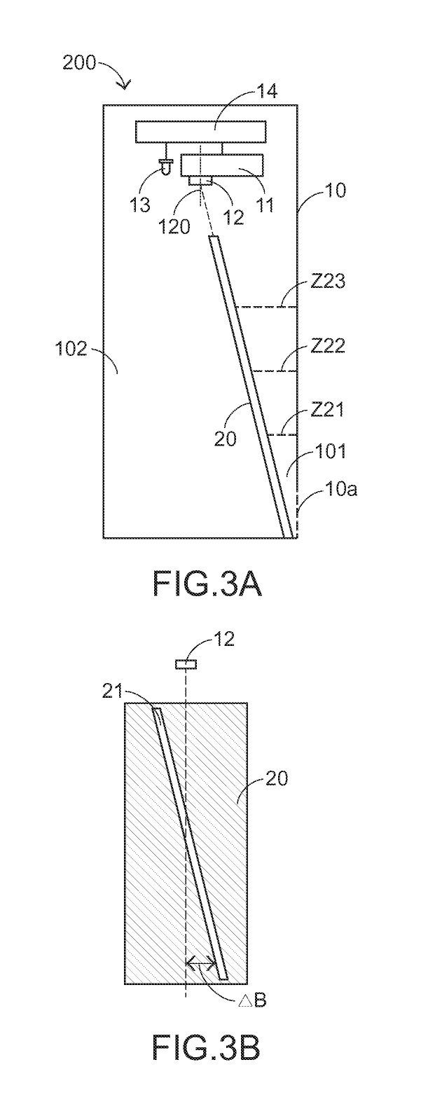

Hereinafter, a liquid level measuring device of a second embodiment of the present invention will be illustrated. FIG. 3A is a schematic view illustrating a liquid level measuring device according to a second embodiment of the present invention. Except that the liquid level measuring device 200 of this embodiment further comprises a partition structure 20, the operating principles and the application of the liquid level measuring device 200 of this embodiment are substantially identical to those of the first embodiment. In this embodiment, the partition structure 20 is a flat plate. The partition structure 20 is disposed within the container 10 and inclined relative to the lower portion of the container 10. Consequently, the inner portion of the container 10 is partitioned into a first region 101 and a second region 102 by the partition structure 20. The first region 101 is located beside the opening 10a, so that the liquid is permitted to flow into the first region 101 through the opening 10a. The second region 102 is kept dry.

FIG. 3B is a schematic side view illustrating the partition structure of the liquid level measuring device according to the second embodiment of the present invention. As shown in FIG. 3B, the partition structure 20 comprises a light-transmissible part 21 with a linear slope. In this embodiment, the light-transmissible part 21 is integrally formed with the partition structure 20. The light-transmissible part 21 is transparent. Whereas, the other surfaces of the partition structure 20 are deeply colored. In an embodiment, the partition structure is produced by a completely-transparent flat plate (e.g. an acrylic plate or a plastic plate) and then painting the flat plate with a deep color pigment, wherein only an oblique line with an inclined angle is not painted. The oblique line is served as the light-transmissible part 21. The light-transmissible part 21 is light-transmissible. Since the other surfaces of the partition structure 20 are deeply colored, there is an obvious brightness difference between the light-transmissible part 21 and the other part of the partition structure 20.

It is noted that numerous modifications and alterations of the light-transmissible part may be made while retaining the teachings of the invention. For example, in another embodiment, the partition structure is a deeply-colored flat plate, and the light-transmissible part comprises a groove and a transparent sheet. That is, for forming the light-transmissible part, an oblique groove with a specified inclined angle is firstly formed in the flat plate, and then the transparent sheet (e.g. an acrylic sheet or a plastic sheet) is disposed within the groove. Alternatively, in some other embodiments, an oblique line is painted on a flat plate, wherein the oblique line and the flat plate have high color contrast. As long as the position of the liquid surface is visible according to the different refractive indices of the liquid and air, the design of the oblique line is not restricted.

Please refer to FIGS. 3A and 3B again. The light source 13 illuminates the second region 102. Similar to the first embodiment, the lens 12 is operated in a fixed focus mode to shoot the second region 102, thereby acquiring an image stream. In this embodiment, an extending line passing through a planar central axis of the partition structure 20 is aligned with a center point of the optical axis 120 of the lens 12.

In the imaging formula U×Z=I×B, both of Z and B are in linear variation. That is, U/I=B/Z=constant. Consequently, when the lens 12 is operated in the fixed focus mode to shoot the second region 102, the focal length I is fixed, and the image length U is fixed. That is, even if the depths Z of the object at different, the image length U is identical. In this embodiment, since the inclined flat plate has an oblique light-transmissible part 21, the change of the liquid surface may be realized by observing the image of the light-transmissible part 21. For a specified depth Z, there is a difference ΔB between the B value of the light-transmissible part 21 and the B value of the central axis of the inclined flat plane. Since ΔU/I=ΔB/Z, ΔU is in direct proportion to ΔB. In other words, the change of ΔB of the light-transmissible part 21 indicates the change of the liquid surface.

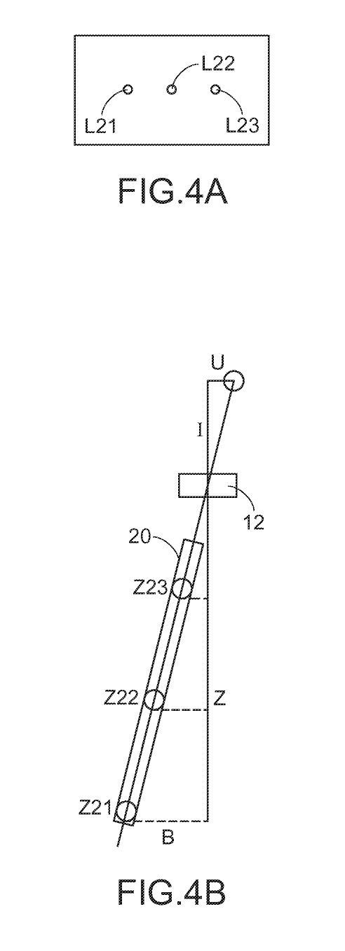

FIG. 4A schematically illustrates a continuous image-capturing result of the liquid level measuring device according to the second embodiment of the present invention. FIG. 4B schematically illustrates the image formation by the lens of the liquid level measuring device according to the second embodiment of the present invention. Since the liquid and the air have different refractive indices, obvious light reflection occurs at the interface between the liquid surface and the air. Moreover, since the light beams emitted by the light source 13 are transmissible through the light-transmissible part 21, the liquid surface image contained in the image frame that is captured by the lens 12 is exhibited in a corresponding bright fringe. In FIG. 4A, the bright fringes L21, L22 and L23 indicate three liquid surface images shot at different time points. In FIGS. 3B and 4B, the elements corresponding to those in FIG. 2B will be designated by identical numeral references. Since the light-transmissible part 21 has a linear slope and the partition structure 20 is inclined relative to the lower portion of the container 10, the rising and lowering situations of the liquid can be indicated by the change of the positions of the bright fringes. In addition, the rising and lowering situations of the liquid and the change of the positions of the bright fringes are in linear relationship.

In FIG. 3A, three liquid levels Z21, Z22 and Z23 are shown. The liquid level Z21 indicates the liquid level at a first time point (e.g. an older time point) and corresponding to the bright fringes L21 of FIG. 4A. The liquid level Z22 indicates the liquid level at a second time point and corresponding to the bright fringes L22 of FIG. 4A. The liquid level Z23 indicates the liquid level at a third time point (e.g. a newer time point) and corresponding to the bright fringes L23 of FIG. 4A. Similar, in FIG. 4A, these three image frames are superimposed with each other in order to facilitate observing the movement of the bright fringe. The method of performing the image analyzing operation on the images captured by the lens 12 is identical to that used in the first embodiment. That is, the Gaussian distribution method or the Centroid method may be used to analyze the sub-pixel accuracy, and is not redundantly described herein. Moreover, in this embodiment, the bright fringes may be further processed (e.g. by a filtering operation). Consequently, the position of the liquid that is transmissible through the light-transmissible part 21 can be clearly located.

For example, if the liquid level change is 2 meters and the width of the flat plate of the partition structure 20 is 0.3 meter, one unit of displacement of the image in the width direction may indicate 6.67 units of the liquid level change (i.e. 2/0.3=6.67). In case that one unit of displacement of the image is recorded by 1000 pixels, each pixel indicates 0.3 millimeter (i.e. 0.3 m/1000=0.3 mm). In other words, one pixel of displacement of the image indicates 2 mm of the actual liquid level change (i.e. 0.3 mm×6.67=2 mm or 2 m/1000=2 mm).

According to the image processing and analyzing technologies described in the first embodiment and in the prior art, if the calculation of the sub-pixel displacement is not performed (i.e. only the calculation of the integer pixel is done), the precision is only one half of a pixel. That is, in this example, the precision is one millimeter (i.e. 2 mm×0.5=1 mm). Whereas, if the calculation of the sub-pixel displacement is performed, the precision is enhanced (e.g. several tenths to several hundredths of one pixel). Consequently, after the positions of the bright fringes shown on two image frames are calculated and compared with each other (i.e. the calculation of the sub-pixel displacement is performed), the liquid level change may be acquired. Under this circumstance, the actual liquid level of the liquid in the detection region is realized. Moreover, the use of the partition structure 20 can increase the measuring precision.

Moreover, in case that the slope of the light-transmissible part 21 is adjusted, the measuring precision is correspondingly adjusted. From the above discussions, as the slope of the light-transmissible part 21 decreases, the measuring precision increases.

In this embodiment, the light source 13 illuminates the second region 102 that does not contain the liquid. However, since the liquid and the air have different refractive indices, even if the light source 13 illuminates the first region 101 containing the liquid, the interface between the liquid surface and the air is clearly visible. Alternatively, in some other embodiments, the second region 102 also has an opening for allowing the liquid to flow through. Under this circumstance, the liquid level in the first region 101 is equal to the liquid level in the second region 102, and the obvious light reflection occurs under the irradiation of the light beams of the light source 13.

It is noted that numerous modifications and alterations of the partition structure 20 may be made while retaining the teachings of the second embodiment.

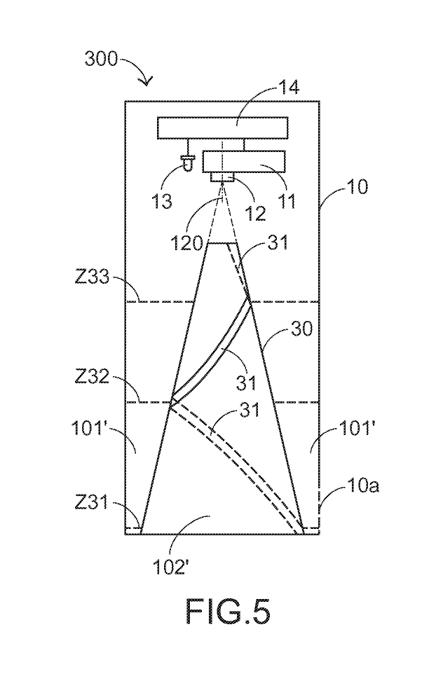

Hereinafter, a liquid level measuring device of a third embodiment of the present invention will be illustrated. FIG. 5 is a schematic view illustrating a liquid level measuring device according to a third embodiment of the present invention. Except that the partition structure 30 of the liquid level measuring device 300 of this embodiment is a cone-shaped structure, the operating principles and the application of the liquid level measuring device 300 of this embodiment are substantially identical to those of the second embodiment. In this embodiment, the partition structure 30 has a circular bottom surface. The lateral surface of the partition structure 30 is inclined relative to the lower portion of the container. Moreover, the inner portion of the cone-shaped structure is hollow, and a circular hole is formed in a top surface of the cone-shaped structure. Similarly, the partition structure 30 is disposed on the lower portion of the container 10. By the partition structure 30, the inner portion of the container 10 is partitioned into a first region 101′ and a second region 102′. The liquid is permitted to flow into the first region 101′ through the opening 10a.

As shown in FIG. 5, the partition structure 30 comprises a light-transmissible part 31. The light-transmissible part 31 also has a linear slope. The way of forming the light-transmissible part 31 is similar to the way of forming the light-transmissible part 21 of the second embodiment, and is not redundantly described herein. In this embodiment, since the partition structure 30 is the cone-shaped structure, the light-transmissible part 31 is arranged in a helical line. In particular, the light-transmissible part 31 is traveled from the bottom to the top of the partition structure 30 at a specified slope and around the lateral surface of the partition structure 30 for one turn. Moreover, in this embodiment, the light source 13 illuminates the first region 101′ that contains the liquid, and the lens 12 is operated in the fixed-focus mode to shoot the second region 102′.

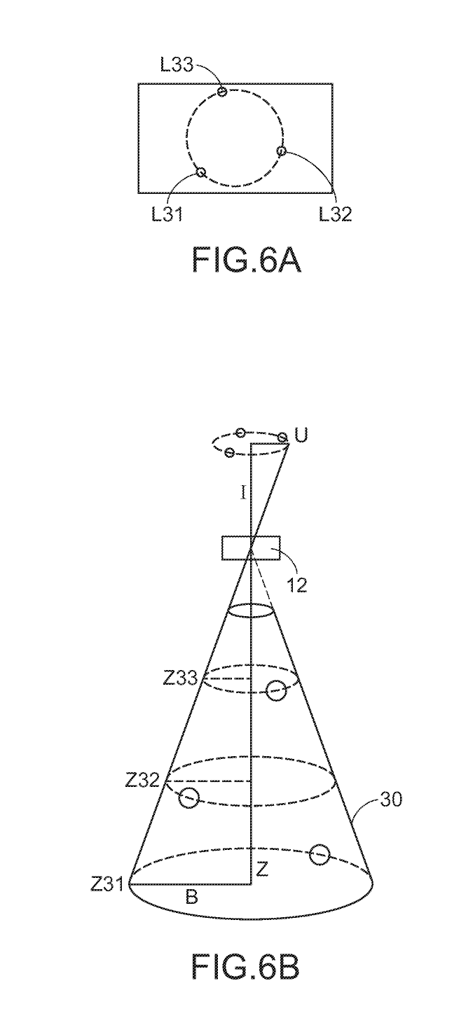

FIG. 6A schematically illustrates a continuous image-capturing result of the liquid level measuring device according to the third embodiment of the present invention. FIG. 6B schematically illustrates the image formation by the lens of the liquid level measuring device according to the third embodiment of the present invention. Similarly, since obvious light reflection occurs at the interface between the liquid surface and the air, the liquid surface image contained in the captured image frame is exhibited in a corresponding bright fringe. In FIG. 6A, the bright fringes L31, L32 and L33 indicate three liquid surface images shot at different time points. In FIGS. 5 and 6B, the elements corresponding to those in FIG. 2B will be designated by identical numeral references. Since the light-transmissible part 31 has a linear slope and the partition structure 30 is inclined relative to the lower portion of the container 10, the rising and lowering situations of the liquid can be indicated by the change of the positions of the bright fringes. In addition, the rising and lowering situations of the liquid and the change of the positions of the bright fringes are in linear relationship. Under this circumstance, even if the liquid levels Z31, Z32 and Z33 are different, the image length U is fixed. In addition, the bright fringe is moved along a circular trajectory. That is, a circumference with the same radius is formed on the image.

In FIG. 5, three liquid levels Z31, Z32 and Z33 are shown. The liquid level Z31 indicates the liquid level at a first time point (e.g. an older time point) and corresponding to the bright fringes L31 of FIG. 6A. The liquid level Z32 indicates the liquid level at a second time point and corresponding to the bright fringes L32 of FIG. 6A. The liquid level Z33 indicates the liquid level at a third time point (e.g. a newer time point) and corresponding to the bright fringes L33 of FIG. 6A. Similar, in FIG. 6A, these three image frames are superimposed with each other in order to facilitate observing the movement of the bright fringe. The method of performing the image analyzing operation is identical to that used in the above embodiments.

For example, if the liquid level change is 2 meters and the diameter of the bottom surface of the cone-shaped partition structure 30 is 0.3 meter and the diameter of the circular trajectory of the bright fringe is recorded by 1000 pixels, the circular trajectory of the bright fringe is recorded by 3141 pixels (i.e. π×1000=3141). In other words, one pixel of displacement of the image indicates 0.64 mm of the liquid level change (i.e. 2 m/3141=0.64 mm). Consequently, after the positions of the bright fringes shown on any two image frames are calculated and compared with each other (i.e. the calculation of the sub-pixel displacement is performed), the liquid level change may be acquired. Under this circumstance, the actual liquid level of the liquid in the detection region is realized. Moreover, in comparison with the inclined flat plate, the use of the cone-shaped partition structure 30 can further increase the measuring precision.

Moreover, in case that the slope of the light-transmissible part 31 is adjusted, the measuring precision is correspondingly adjusted. From the above discussions, as the slope of the light-transmissible part 31 decreases, the measuring precision increases. Moreover, the decrease of the slope of the light-transmissible part 31 indicates more turns of travelling the light-transmissible part 31 from the bottom to the top of the partition structure 30.

It is noted that numerous modifications and alterations of the partition structure may be made while retaining the teachings of the second embodiment and the third embodiment. For example, in some other embodiments, the partition structure is a trapezoidal pyramid structure. The trapezoidal pyramid structure has a square bottom surface and four trapezoidal lateral surfaces. Moreover, the trapezoidal pyramid structure is inclined relative to the lower portion of the container, the inner portion of the trapezoidal pyramid structure is hollow, and a square hole is formed in a top surface of the trapezoidal pyramid structure. Moreover, the light-transmissible part is traveled around the four lateral surfaces of the trapezoidal pyramid structure. According to such design, the bright fringe is moved along a square trajectory. Similarly, after the calculation of the sub-pixel displacement is performed, the liquid level change may be acquired.

From the above embodiments and possible variant examples, the liquid level measuring device of the present invention is capable of effectively measuring the liquid level in the detection region and the liquid level change that varies with time. However, in the above embodiments, since the opening of the liquid level measuring device for allowing the liquid to flow through is located at the lower portion of the container, the applications of the liquid level measuring device is restricted. For example, it is difficult to use the liquid level measuring devices of the above embodiments to measure the quantity of rainfall.

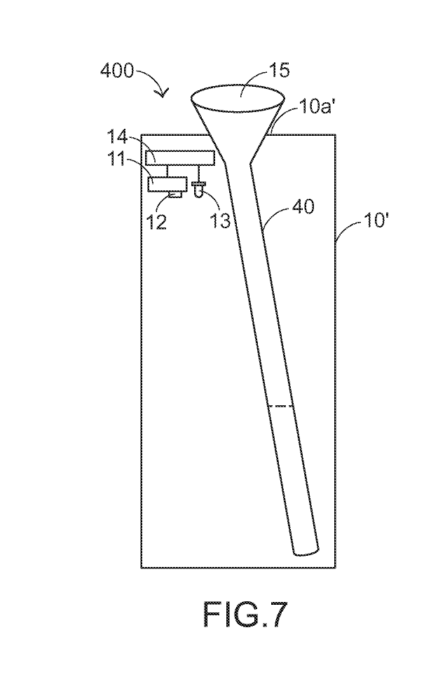

Hereinafter, a liquid level measuring device of a fourth embodiment of the present invention will be illustrated. FIG. 7 is a schematic view illustrating a liquid level measuring device according to a fourth embodiment of the present invention. Except that the opening 10a′ is formed in an upper portion of the container 10′ and the container 10′ has a water collector 15, the operating principles and the application of the liquid level measuring device 400 of this embodiment are substantially identical to those of the second embodiment. In this embodiment, the water collector 15 is disposed in the opening 10a′ at the upper portion of the container 10′. Moreover, the liquid level measuring device 400 comprises a partition structure 40. The partition structure 40 is a pipe structure with a fixed diameter. That is, the main body of the pipe structure has a uniform diameter, and the inner portion thereof is hollow. An entrance at the top of the pipe structure is connected with the water collector 15. Similarly, the pipe structure is inclined relative to the lower portion of the container 10′.

Since the partition structure 40 is a pipe structure with a fixed diameter, the cross section area of the pipe structure is fixed. The product of the cross section area of the pipe structure multiplied by the depth of the liquid is equal to the quantity of rainfall. Moreover, the quantity of rainfall divided by the area of the water collector is equal to the rainfall depth per unit area. Moreover, the partition structure 40 also has a light-transmissible part (not shown). The way of forming the light-transmissible part and the corresponding image analyzing operation are similar to those of the second embodiment, and are not redundantly described herein.

Moreover, by referring to the teachings of the fourth embodiment, the liquid level measuring device of the third embodiment may be modified to measure the quantity of rainfall. For example, the outer appearance of the container and the partition structure within the container match each other. That is, the outer appearance of the container is also cone-shaped. Consequently, the first region that contains the liquid has a uniform diameter. After an opening (or more than one opening) is formed in the upper portion of the container or a corresponding water collector (or more than one water collector) is installed, the efficacy of accurately measuring the quantity of rainfall is also achievable.

From the above descriptions, the present invention provides a liquid level measuring device. For effectively measuring the liquid level and applying to different situations, an opening may be located at a lower portion or an upper portion of a container. Moreover, although the container is not completely sealed, as shown in the above drawings, a digital electronic device and a lens of the liquid level measuring device are still disposed within a relatively sealed environment. That is, since the ambient light beams are nearly blocked from entering the container, the quality of the captured image is not interfered by the ambient light beams. Since the container of the liquid level measuring device of the present invention is capable of blocking the ambient light beams and shielding the inner components, the container may be also referred as a shielding container.

In the above embodiments, the lens is operated in the fixed focus mode. However, for acquiring an appropriate image frames or displaying range, the lens may be manually manipulated (e.g. remotely controlled) to be zoomed in or zoomed out according to the liquid level change. Moreover, in some practical situations, the liquid level measuring device is not ideally installed in the detection region. For example, if the terrain in the detection region is bumpy, the optical axis of the lens is not ideally perpendicular to the detection plane (i.e. the liquid surface). That is, the optical axis of the lens may be tilted. After associated image analyzing technologies are performed to calculate and convert the image data of the liquid surface image, the liquid level at the detection region can also be effectively realized.

Alternatively, in some embodiments, the partition structure may be designed as a cylindrical structure. Under this circumstance, the cylindrical structure is not inclined relative to the lower portion of the container. Whereas, the cylindrical structure is perpendicular to the lower portion of the container. The slope of the light-transmissible part is non-linear. In particular, the slope of the light-transmissible part is inversely related to the water level. That is, the slope of the light-transmissible part varies with the altitude of the light-transmissible part relative to the bottom surface of the cylindrical structure. For example, the slope of the light-transmissible part corresponding to the lower altitude of the cylindrical structure is smaller, and the slope of the light-transmissible part corresponding to the higher altitude of the cylindrical structure is larger. In such design, if the liquids at different depths have the identical liquid level change, the image distance is identical. Consequently, the uniform measuring precision is achievable.

In the liquid level measuring device of the above embodiments, the container is made of an opaque material, and the outer appearance of the container is designed as a sealed structure. Since the ambient light beams are nearly blocked from entering the container, the processes of capturing images are not interfered by the ambient light beams. Moreover, since the known digital electronic device and the known light source are employed for capturing images, processing and analyzing images, transmitting signals and illuminating the detection plane, the installation cost of the liquid level measuring device is reduced, and associated images and information can be immediately transmitted to the back-end device to be used and watched by the user. Moreover, by means of the inclined partition structure and the light-transmission part and by analyzing the sub-pixel accuracy of the captured images, the liquid level change can be measured more accurately and precisely. Consequently, the liquid level of the liquid in the detection region can be accurately realized.

As a consequence, the liquid level measuring device of the present invention is effective to solve the problems encountered from the prior art technology and achieve industrial advance and development.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A liquid level measuring device, comprising:
a container located at a detection region, wherein the container has an opening, so that a liquid is permitted to flow into the container through the opening; and
a digital electronic device combined with the container, wherein the digital electronic device comprises a lens, and an optical axis of the lens is directed to and perpendicular to a detection plane, wherein a light source illuminates the detection plane, and the lens is operated in a fixed-focus mode to shoot the detection plane to acquire an image stream,
wherein each image frame of the image stream contains a corresponding liquid surface image, wherein after an image analyzing operation is performed on the corresponding liquid surface image to calculate the corresponding liquid surface image, a liquid level of the liquid is realized.

2. The liquid level measuring device according to claim 1, wherein the opening is located at a lower portion of the container.

3. The liquid level measuring device according to claim 1, wherein the container is a cylindrical or tubal structure with a closed top end, the container is made of an opaque material, and a height of the container is determined according to the detection region.

4. The liquid level measuring device according to claim 1, wherein the container has an inner wall, wherein each image frame of the image stream contains an image of a part of the inner wall and the corresponding liquid surface image.

5. The liquid level measuring device according to claim 1, wherein the light source is included in the digital electronic device, or the light source and the digital electronic device are separate units, wherein the light source comprises at least one light emitting diode unit.

6. The liquid level measuring device according to claim 1, further comprising an external power source for providing electric power to the digital electronic device and the light source, wherein the external power source is a utility power source, a solar energy supply unit or a wind power supply unit.

7. The liquid level measuring device according to claim 1, wherein the digital electronic device is a smart phone, a tablet personal computer, a notebook computer or a web camera.

8. The liquid level measuring device according to claim 1, wherein the digital electronic device comprises:
a memory unit;
a central processing unit for processing the image stream and storing the image stream into the memory unit, wherein when the liquid level reaches a preset value, the central processing unit generates a corresponding warning signal; and
a signal transmission unit for transmitting the warning signal or the image stream in a wired transmission manner or a wireless transmission manner.

9. The liquid level measuring device according to claim 8, wherein the image analyzing operation is performed by the central processing unit, wherein for performing the image analyzing operation, an area of the liquid surface image contained in each image frame is calculated, or changes of liquid surface edges of two image frames are calculated and compared with each other, and a Gaussian distribution method or a Centroid method is further used to analyze a sub-pixel accuracy, so that the corresponding liquid level is acquired.

10. The liquid level measuring device according to claim 1, further comprising a partition structure, wherein the partition structure is disposed within the container and inclined relative to a lower portion of the container, and the partition structure comprises a light-transmissible part with a linear slope, wherein the corresponding liquid surface image is an image of the liquid which is visible through the light-transmissible part, and the corresponding liquid surface image is indicated as a bright fringe.

11. The liquid level measuring device according to claim 10, wherein after the partition structure is disposed within the container, an inner portion of the container is partitioned into a first region and a second region by the partition structure, wherein the liquid flows into one or both of the first region and the second region.

12. The liquid level measuring device according to claim 10, wherein the light-transmissible part is integrally formed with the partition structure, wherein the light-transmissible part is transparent, and the other surfaces of the partition structure are deeply colored.

13. The liquid level measuring device according to claim 10, wherein the light-transmissible part comprises a groove and a transparent sheet, wherein the transparent sheet is disposed within the groove.

14. The liquid level measuring device according to claim 10, wherein the partition structure is a flat plate, a trapezoidal pyramid structure or a cone structure, wherein the light-transmissible part is arranged in an oblique line or a helical line.

15. The liquid level measuring device according to claim 10, wherein the opening is formed on an upper portion of the container, and a water collector is disposed in the opening of the container, wherein the partition structure is a pipe structure with a fixed diameter and connected with the water collector.

16. The liquid level measuring device according to claim 10, wherein for performing the image analyzing operation, positions of the bright fringes of any two image frames are calculated and compared with each other, and a Gaussian distribution method or a Centroid method is further used to analyze a sub-pixel accuracy, so that the corresponding liquid level is acquired.

17. The liquid level measuring device according to claim 10, wherein the lens faces the lower portion of the container, wherein an extending line passing through a planar central axis of the partition structure is aligned with a center point of the optical axis of the lens.

18. A liquid level measuring device, comprising:
a shielding container located at a detection region, wherein the shielding container has an opening, so that a liquid is permitted to flow into the container through the opening; and
a digital electronic device disposed within the shielding container, wherein the digital electronic device comprises a lens, and an optical axis of the lens is directed to a detection plane, wherein a light source illuminates the detection plane, and the lens shoots the detection plane to acquire an image stream,
wherein each image frame of the image stream contains a corresponding liquid surface image, wherein after an image analyzing operation is performed on the corresponding liquid surface image to calculate the corresponding liquid surface image, a liquid level of the liquid is realized.

19. The liquid level measuring device according to claim 18, further comprising a partition structure, wherein the partition structure is disposed within the shielding container, and inclined relative to a lower portion of the shielding container or perpendicular to the lower portion of the shielding container, wherein the partition structure comprises a light-transmissible part with a linear slope or a non-linear slope.

20. The liquid level measuring device according to claim 18, wherein for performing the image analyzing operation, positions or areas or changes of liquid surface edges of any two image frames are calculated and compared with each other, and a Gaussian distribution method or a Centroid method is further used to analyze a sub-pixel accuracy, so that the corresponding liquid level is acquired.
